(19) United States
(12) Patent Application Publication
(10) Pub. No.: US 2026/0189890 A1
(43) Pub. Date: Jul. 2, 2026

(54) LOCATION- AND WORKLOAD-BASED CALL ROUTING FOR NEXT-GENERATION 911 SERVICES

(71) Applicant: AT&T Intellectual Property I, L.P., Atlanta, GA (US)

(72) Inventors: Yu Zhou, Somerset, NJ (US); Anwar Syed Aftab, Budd Lake, NJ (US); Manoop Talasila, Branchburg, NJ (US)

(21) Appl. No.: 19/004,373

(22) Filed: Dec. 29, 2024

(51) Int. Cl. H04W 4/90; H04W 4/024; H04W 64/00

(52) U.S. Cl. CPC H04W 4/90; H04W 4/024; H04W 64/00

(57) ABSTRACT

A method includes receiving, from each public safety answering point, a respective set of data, where the respective set of data comprises real-time workload data for the each public safety answering point and real-time workload data for each response team, receiving from a user endpoint device a call requesting an emergency service, determining a location of the user endpoint device, calculating a plurality of travel times, wherein each travel time represents an estimated amount of time for one response team to reach the location, estimating, based on the plurality of travel times and on the real-time workload data, a plurality of response times, wherein each response time represents a time to respond to the call, selecting a first public safety answering point and a first response team to assign to the call, and routing the call to one of: the first public safety answering point or the first response team.

The present disclosure relates generally to wireless communications networks, and relates more particularly to devices, non-transitory computer-readable media, and methods for location- and workload-based call routing for next-generation 911 services.

### BACKGROUND

Next-generation 911 (NG911) and similar services allow individuals who are experiencing emergencies to make voice, text, or video calls from any communications device, via Internet Protocol (IP) networks. Compared to traditional 911 systems which typically allow voice calls with limited data delivered, NG911 provides faster, more flexible, more resilient, and more scalable responses to emergencies.

### SUMMARY

In one example, the present disclosure describes a device, computer-readable medium, and method for location- and workload-based call routing for next-generation 911 services. For instance, in one example, a method performed by a processing system including at least one processor includes receiving, from each public safety answering point of a plurality of public safety answering points in an emergency telecommunications services network, a respective set of data, where the respective set of data comprises real-time workload data for the each public safety answering point and real-time workload data for each response team of a plurality of response teams associated with the each public safety answering point, receiving from a user endpoint device, a call requesting an emergency service, determining a physical location of the user endpoint device, calculating, based on the physical location, the real-time workload data for the each response team, and real-time road traffic data, a plurality of travel times, wherein each travel time of the plurality of travel times represents an estimated amount of time for one response team of the plurality of response teams associated with the each public safety answering point to reach the physical location, estimating, based on the plurality of travel times and on the real-time workload data for the each public safety answering point, a plurality of response times, wherein each response time of the plurality of response times represents a time to respond to the call, selecting, based on the plurality of response times, a first public safety answering point of the plurality of public safety answering points and a first response team of the plurality of response teams to assign to the call, and routing the call to at least one of: the first public safety answering point or the first response team.

In another example, a non-transitory computer-readable medium stores instructions which, when executed by the processing system, cause the processing system to perform operations. The operations include receiving, from each public safety answering point of a plurality of public safety answering points in an emergency telecommunications services network, a respective set of data, where the respective set of data comprises real-time workload data for the each public safety answering point and real-time workload data for each response team of a plurality of response teams associated with the each public safety answering point, receiving from a user endpoint device, a call requesting an emergency service, determining a physical location of the user endpoint device, calculating, based on the physical location, the real-time workload data for the each response team, and real-time road traffic data, a plurality of travel times, wherein each travel time of the plurality of travel times represents an estimated amount of time for one response team of the plurality of response teams associated with the each public safety answering point to reach the physical location, estimating, based on the plurality of travel times and on the real-time workload data for the each public safety answering point, a plurality of response times, wherein each response time of the plurality of response times represents a time to respond to the call, selecting, based on the plurality of response times, a first public safety answering point of the plurality of public safety answering points and a first response team of the plurality of response teams to assign to the call, and routing the call to at least one of: the first public safety answering point or the first response team.

In another example, a system includes a processing system including at least one processor and a non-transitory computer-readable medium storing instructions which, when executed by the processing system, cause the processing system to perform operations. The operations include receiving, from each public safety answering point of a plurality of public safety answering points in an emergency telecommunications services network, a respective set of data, where the respective set of data comprises real-time workload data for the each public safety answering point and real-time workload data for each response team of a plurality of response teams associated with the each public safety answering point, receiving from a user endpoint device, a call requesting an emergency service, determining a physical location of the user endpoint device, calculating, based on the physical location, the real-time workload data for the each response team, and real-time road traffic data, a plurality of travel times, wherein each travel time of the plurality of travel times represents an estimated amount of time for one response team of the plurality of response teams associated with the each public safety answering point to reach the physical location, estimating, based on the plurality of travel times and on the real-time workload data for the each public safety answering point, a plurality of response times, wherein each response time of the plurality of response times represents a time to respond to the call, selecting, based on the plurality of response times, a first public safety answering point of the plurality of public safety answering points and a first response team of the plurality of response teams to assign to the call, and routing the call to at least one of: the first public safety answering point or the first response team.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for location- and workload-based call routing for next-generation 911 services may operate;

FIG. 2 illustrates a flowchart of an example method for location- and workload-based call routing for next-generation 911 services, according to the present disclosure;

FIG. 3 illustrates a flowchart of an example method for priority-based call routing for next-generation 911 services, according to the present disclosure; and

FIG. 4 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure provides a system, method, and non-transitory computer readable medium for location- and workload-based call routing for next-generation 911 services. As discussed above, next-generation 911 (NG911) and similar services allow individuals who are experiencing emergencies to make voice, text, or video calls from any communications device, via Internet Protocol (IP) networks. Compared to traditional 911 systems which typically allow voice calls with limited data delivered, NG911 provides faster, more flexible, more resilient, and more scalable responses to emergencies.

In modern NG911 systems, when a mobile user places a call for emergency services (e.g., a call to 911), the user's endpoint device which is used to make the call (e.g., the user's smart phone, tablet computer, autonomous vehicle, or the like) connects to a base station of an access network. The cell that is served by that base station is typically mapped to a specific public safety answering point (PSAP), which identifies and dispatches the appropriate first response personnel to respond to the emergency. For instance, the PSAP may identify the appropriate police department to respond to the emergency and either dispatch personnel from that police department or transfer the user's call to that police department. Typically, the appropriate police department is considered to be the police department whose location is closest to the location of the emergency. Although this approach often results in the user being connected with the first responders who are nearest to the user's location, this is not always the case. For instance, if the user's location is at the boundary of two cells that are mapped to different PSAPs, the user's call may end up being routed to the PSAP that is further away from the user's location.

Alternatively, instead of routing a call to a PSAP based on a mapping to the serving cell for the call, the base station may route the call to the PSAP that is nearest to the user's location. However, even this approach has some limitations. For instance, the user may have to wait longer than is ideal for help if the nearest PSAP is currently handling a large volume of calls, or if all first responder teams associated with the nearest PSAP have already been dispatched to other emergencies or are located far from the user's location.

Examples of the present disclosure introduce a network function for the NG911 emergency services IP network (ESInet) that routes user calls to PSAPs based on the current call volumes associated with the PSAPs and the first responder teams. ESInet is a nation-wide IP-based network that enables emergency services to communicate with each other during emergencies. ESInet is designed to provide a reliable and secure platform for emergency services to share critical information such as voice, data, and video in real time.

The ESInet architecture is based on a distributed model, where emergency services are connected to a central hub through a secure IP network. The central hub acts as a gateway, routing emergency calls and data to the appropriate emergency services agencies (e.g., police, fire, ambulance, etc.). ESInet is designed to be highly resilient, with redundant connections and failover mechanisms to ensure that emergency services can continue to communicate even in the event of a network outage.

The functionalities of ESInet include call routing (e.g., enabling calls for emergency assistance to be routed to the appropriate emergency services based on the caller's location), location identification (e.g., using advanced location technologies, such as global positioning systems, WiFi, and Bluetooth, to identify a caller's location), data sharing (e.g., sharing critical information such as incident reports, images, and videos in real time), and interoperability (e.g., interoperability with other emergency services networks, which enables seamless communication between different agencies during emergencies).

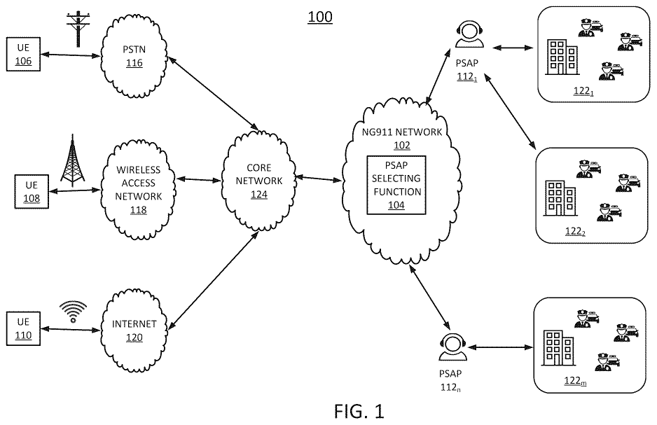

By accounting for current call volumes associated with PSAPs and the first responder teams, examples of the present disclosure can reduce the average response time experienced by users who place calls for emergency assistance. In further examples, user endpoint devices in an ESInet may each be assigned to one of a plurality of priority classes (where, e.g., user endpoint devices associated with first responders may be assigned to a highest priority class of the plurality of priority classes). When the network is congested and NG911 resources are limited, the priority classes may be used to prioritize callers according to a proportional-fairness utility function. These and other aspects of the present disclosure are discussed in further detail with reference to FIGS. 1-4, below.

To further aid in understanding the present disclosure, FIG. 1 illustrates an example system 100 in which examples of the present disclosure for location- and workload-based call routing for next-generation 911 services may operate. The system 100 may include any one or more types of communication networks, such as a traditional circuit switched network (e.g., a public switched telephone network (PSTN) 116) or a packet network such as an Internet Protocol (IP) network (e.g., an IP Multimedia Subsystem (IMS) network 124), an asynchronous transfer mode (ATM) network, a wired network, a wireless network, and/or a wireless access network 118, e.g., a cellular access network (e.g., 2G-5G, a long term evolution (LTE) network, and the like) related to the current disclosure. It should be noted that an IP network is broadly defined as a network that uses Internet Protocol to exchange data packets. Additional example IP networks include Voice over IP (VoIP) networks, Service over IP (SoIP) networks, the World Wide Web, and the like.

In one example, the system 100 may comprise a core network 124. The core network 124 may be in communication with one or more access networks, such as PTSN 116 and wireless access network 118, and with the Internet 120. In one example, the core network 124 may functionally comprise a fixed mobile convergence (FMC) network, e.g., an IP Multimedia Subsystem (IMS) network. In addition, the core network 124 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. For ease of illustration, various additional elements of the core network 124 are omitted from FIG. 1.

In one example, the PSTN 116 may comprise a collection of telephone lines, fiber-optic cables, microwave transmission links, cellular networks, communications satellites, and undersea telephone cables interconnected by switching centers (e.g., such central offices, network tandems, and international gateways) which allow telephone users to communicate with each other.

In one example, the wireless access network 118 may comprise a wireless local area network, a wireless access network (e.g., an IEEE 802.11/Wi-Fi network and the like), a cellular access network, a third party network, and the like. In one example, the core network 124 may be operated by a telecommunication network service provider (e.g., an Internet service provider, or a service provider who provides Internet services in addition to other telecommunication services). The core network 124 and the PSTN 116 and/or wireless access network 118 may be operated by different service providers, the same service provider or a combination thereof, or the PSTN 116 and wireless access network 118 may be operated by entities having core businesses that are not related to telecommunications services, e.g., corporate, governmental, or educational institution LANs, and the like.

The Internet 120 may comprise the public Internet, i.e., a network of networks that consists of private, public, academic, business, and government networks of local to global scope, linked by a broad array of electronic, wireless, and optical networking technologies.

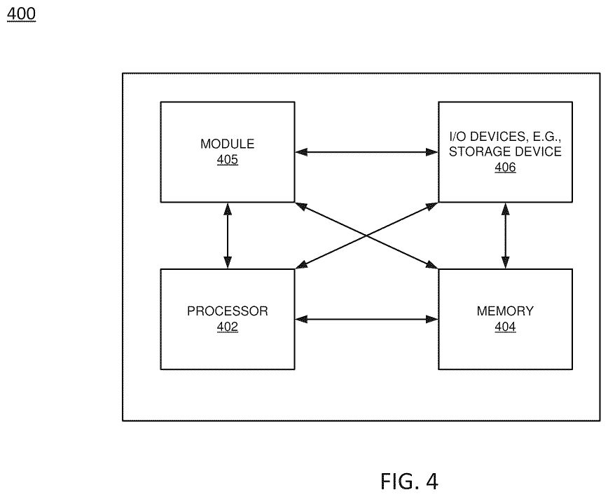

In one example, the PSTN 116 may be in communication with one or more user endpoint devices including user equipment (UE) 106. In one example, the wireless access network 118 may be in communication with one or more user endpoint devices including UE 108. In one example, the Internet 120 may be in communication with one or more user endpoint devices including UE 110. The networks 116, 118, and 120 may transmit and receive communications between the UEs 106, 108, and 110, between the user endpoint devices 106, 108, and 110 and components of the core network 124, devices reachable via the Internet 120 in general, and so forth. In one example, each of the UEs 106, 108, and 110 may comprise any single device or combination of devices that may comprise a user endpoint device, such as computing system 400 depicted in FIG. 4, and may be configured as described below. For example, the UEs 106, 108, and 110 may each comprise a landline telephone, a smart phone, a tablet computer, a laptop computer, a gaming device, an autonomous vehicle, an unmanned aerial vehicle (UAV), a wearable smart device (e.g., a smart watch, smart glasses, or the like), an Internet of Things (IoT) device, a bank or cluster of such devices, and the like.

The core network 124 may connect the UEs 106, 108, and 110 to a NG911 network 102, such as ESInet. The NG911 network 102 may, in turn, be connected to a plurality of public safety answering points (PSAPs) 112₁-112ₙ (hereinafter individually referred to as a “PSAP 112” or collectively referred to as “PSAPs 112”). Each PSAP 112 may connected to one or more first responder response teams 122₁-122ₘ (hereinafter individually referred to as a “response team 122” or collectively referred to as “response teams 122”). Each response team 122 may comprise a combination of first responder personnel and resources, such as a police vehicle and one or more police officers, or an ambulance vehicle and one or more emergency medical technicians. When a call for emergency services is routed from one of the UEs 106, 108, or 110 to the NG911 network 102 (e.g., via the appropriate network 116, 118, or 120 and the core network 124), the call will be assigned to one of the PSAPs 112, which in turn will assign the call to one of its response teams 122.

As discussed above, the current practice is to assign a call to the PSAP that is mapped to the component of the access network that is nearest to the calling UE. For instance, if the UE 108 placed a call for emergency services, the call would be routed to the PSAP 112 that is mapped to the base station (e.g., eNodeB or gNodeB) via which the UE 108 connected to the wireless access network 118, e.g., a cellular access network. Alternatively, the call could be routed to the PSAP 112 that is closest to the physical location of the UE 108.

According to examples of the present disclosure, however, the call from the UE 108 may be handled by a PSAP selecting function (PSF) 104 of the NG911 network before being assigned to a PSAP 112. In practice, each response team 122 may periodically report workload data (e.g., a current physical location of the response team 122 (e.g., GPS coordinates), whether the response team 122 is currently idle or currently responding to an emergency, an estimated time to finish responding to an emergency (if the response team 122 is currently responding to an emergency), and/or other information) to its corresponding PSAP 112. The PSAP 112 may then periodically report this workload data, along with workload data of the PSAP 112 (e.g., a call volume (e.g., number of calls) currently being handled by the PSAP 112, a current average call waiting time (e.g., time that a caller must wait for his or her call to be answered by the PSAP 112) for incoming calls to the PSAP 112, and/or other information), to the PSF 104.

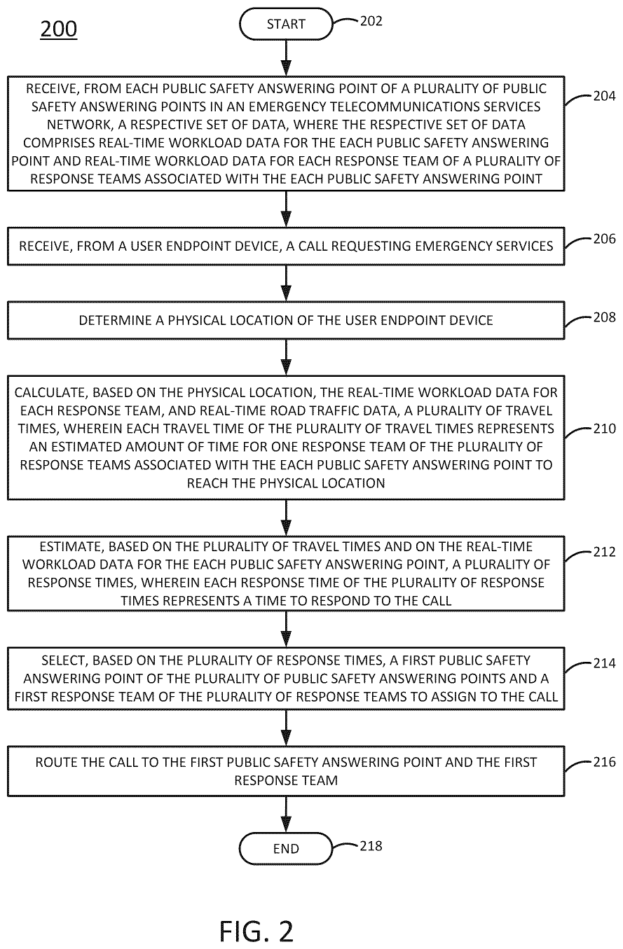

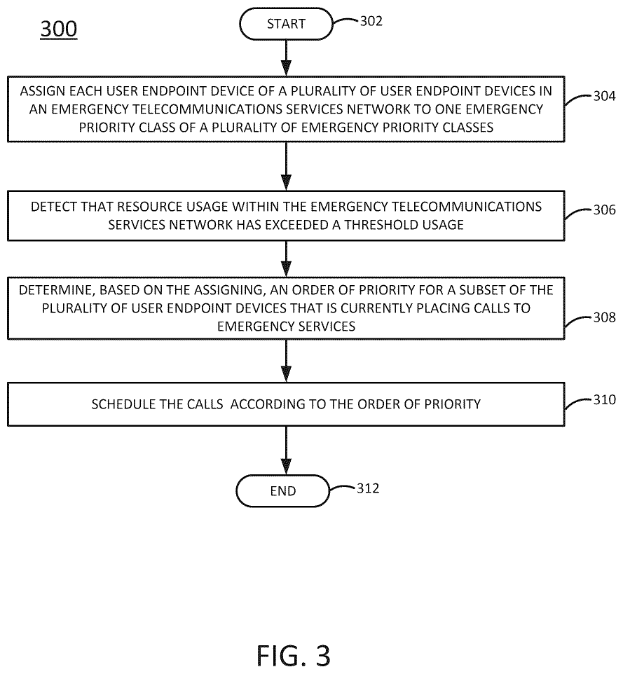

The PSF 104 may thus periodically collect workload data for all of the PSAPs 112 and all of the response teams 122 in the system 100. Then, when the NG911 network 102 receives the call from the UE 108, the PSF 104 may select the optimal PSAP 112 and response team 122 to handle the call based on the physical location of the US 108, the physical locations of the response teams 122, the presence of road traffic, the workloads of the PSAPs 112, and other factors. Details of example methods for routing calls to the NG911 network 102 by the PSF 104 are described below in connection with FIGS. 2 and 3.

The PSF 104 may comprise one or more physical devices, e.g., one or more computing systems or servers, such as computing system 400 depicted in FIG. 4, and may be configured as described below. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For example, the system 100 may include other network elements (not shown) such as border elements, routers, switches, policy servers, security devices, gateways, a content distribution network (CDN) and the like. For example, portions of the core network 124, PSTN 116, wireless access network 118, and/or Internet 120 may comprise a content distribution network (CDN) having ingest servers, edge servers, and the like. Similarly, although only one of each of the PSTN 116 and wireless access network 118 is illustrated, in other examples, PSTN 116 and/or wireless access network 118 may each comprise a plurality of different access networks that may interface with the core network 124 independently or in a chained manner. Thus, these and other modifications are all contemplated within the scope of the present disclosure.

To further aid in understanding the present disclosure, FIG. 2 illustrates a flowchart of an example method 200 for location- and workload-based call routing for next-generation 911 services, according to the present disclosure. In one example, the method 200 may be performed by a PSAP selecting function, such as the PSF 104 illustrated in FIG. 1 or one or more components thereof (e.g., a processor or controller of the base station). However, in other examples, the method 200 may be performed by another device, such as the computing system 400 of FIG. 4, discussed in further detail below. For the sake of discussion, the method 200 is described below as being performed by a processing system (where the processing system may comprise a component of a PSF 104, the computing system 400, or another device).

The method 200 begins in step 202. In step 204, the processing system may receive, from each public safety answering point of a plurality of public safety answering points in an emergency telecommunications services network, a respective set of data, where the respective set of data comprises real-time workload data for the each public safety answering point and real-time workload data for each response team of a plurality of response teams associated with the each public safety answering point.

In one example, the emergency telecommunications services network may be ESInet or a larger network within which ESInet may operate. Each PSAP in the emergency telecommunications services network may comprise a call center that receives incoming calls from users requesting emergency services (e.g., police, fire, ambulance, etc.). Moreover, each PSAP may be associated with a respective plurality of response teams, where each response team may comprise a team of one or more first response personnel and resources that can be dispatched to respond to an emergency. For instance, in one example, a response team may comprise a police vehicle and one or more police officers travelling in the police vehicle, or an ambulance vehicle and one or more emergency medical technicians travelling in the ambulance vehicle.

In one example, each response team may periodically report its real-time workload data to the PSAP with which the response team is associated. In one example, the real-time workload data for the response team may include at least one of: a current physical location of the response team (e.g., GPS coordinates), whether the response team is currently idle or currently responding to an emergency, an estimated time to finish responding to an emergency (if the response team is currently responding to an emergency), and/or other information.

The PSAP may collect the real-time workload data that is periodically reported by each of the response teams with which the PSAP is associated. In turn, the PSAP may periodically report the real-time workload data for its response teams to the processing system. Additionally, the PSAP may periodically report its own real-time workload data to the processing system. In one example, the real-time workload data for the PSAP may include at least one of: a call volume (e.g., number of calls) currently being handled by the PSAP, a current average call waiting time (e.g., time that a caller must wait for his or her call to be answered by the PSAP) for incoming calls to the PSAP, and/or other information.

In step 206, the processing system may receive, from a user endpoint device, a call requesting emergency services. In one example, the call may be routed to the processing system via a base station of a radio access network that is connected to the emergency telecommunications services network. Thus, in one example, the user endpoint device may be a mobile device. However, in other examples, the user endpoint device may be a non-mobile device, such as a landline telephone. In this case, the call may be routed to the processing system via an element of a public switched telephone network (PSTN).

In step 208, the processing system may determine a physical location of the user endpoint device. In one example, the physical location may comprise GPS coordinates of the user endpoint device, which the user endpoint device may provide to the processing system in the call. In another example, the physical location may be determined through triangulation based on the locations of base stations of a radio access network with which the user endpoint device can communicate.

In step 210, the processing system may calculate, based on the physical location, the real-time workload data for the each response team, and real-time road traffic data, a plurality of travel times, wherein each travel time of the plurality of travel times represents an estimated amount of time for one response team of the plurality of response teams associated with the each public safety answering point to reach the physical location.

In one example, the processing system may first calculate, based on the physical location of the user endpoint device and the current physical locations of the plurality of response teams, a plurality of distances between each of the response teams and the physical location of the user endpoint device. This will inform the processing system how close, physically, each response team is to the physical location of the user endpoint device. However, just because one response team may be physically closer to the user endpoint device than another response team, this does not necessarily guarantee that the closer response team will be able to reach the user endpoint device more quickly. For instance, if there is construction, or an accident, or heavy traffic on the route between the closer response team and the physical location of user endpoint device, then this may delay the closer response team in reaching the physical location of the user endpoint device.

Thus, the processing system may account for the real-time road traffic data along the routes between the plurality of response teams and the physical location of the user endpoint device. For instance, for each combination of user endpoint device and response team, the processing system may execute a navigation algorithm to calculate the quickest route to the user endpoint device. In one example, the processing system may then rank all of the response teams (e.g., all response teams associated with all PSAPs) in ascending order based on travel time (e.g., from shortest travel time to longest travel time).

In step 212, the processing system may estimate, based on the plurality of travel times and on the real-time workload data for the each public safety answering point, a plurality of response times, wherein each response time of the plurality of response times represents a time to respond to the call.

In one example, the response time for a given combination of PSAP and response team may comprise a sum of the current average call waiting time for the PSAP plus the travel time that was calculated for the response team. Thus, if the current average call waiting time for a PSAP is thirty seconds, and the travel time for a response team associated with the PSAP is three minutes, then the response time for the PSAP and response team would be three minutes and thirty seconds. The processing system may calculate the response time in this manner for each possible combination of PSAP and response team.

In step 214, the processing system may select, based on the plurality of response times, a first public safety answering point of the plurality of public safety answering points and a first response team of the plurality of response teams to assign to the call.

In one example, the processing system may select the combination of PSAP and response team for which the response time is the shortest among all of the plurality of response times. However, in other examples, there may be a reason to select some other combinations of PSAP and response team. For instance, the response team that is capable of reaching the user endpoint device the quickest may not have all of the necessary resources to respond to the emergency, or may be required to respond to an emergency that is considered more urgent.

In one example, the processing system may select the first PSAP and first response team according to a function f(k), e.g.:

$$f ( k ) = ( i , j ) = \begin{matrix}arg min ( {A}_{i} + {B}_{j , k} ) \\ 1 \leq i \leq R , \\ 1 \leq j \leq S\end{matrix} \qquad ( EQN . 1 )$$

where k represents the user endpoint device, R represents the number of PSAPs in the plurality of PSAPs, S represents the total number of response teams associated with all of the PSAPs, i represents one PSAP in the set of R PSAPs, j represents one response team in the set of S response teams, Aᵢ represents the average call waiting time at one PSAP, and B_{j,k} represents the travel time for one response team to reach the physical location of the user endpoint device k.

In step 216, the processing system may route the call to the first public safety answering point and/or the first response team. In one example, the processing system may route the call so that the user endpoint device is connected to the first PSAP. The processing system may additionally alert the first PSAP to the fact that the first response team was determined to be the optimal response team to respond to the call. In a further example, the processing system may route the call so that the user endpoint device is connected directly to first response team.

It should be noted that in some cases, more than one response team may be needed to respond to an emergency. For instance, a vehicular accident with multiple vehicles involved, or a localized catastrophic weather event, may result in multiple individuals requiring emergency assistance. In this case, the processing system may select multiple PSAP/response team pairs in step 214 and in step 216 may route the call to each PSAP/response team pair of the multiple PSAP/response team pairs. The method 200 may end in step 218.

To further aid in understanding the present disclosure, FIG. 3 illustrates a flowchart of an example method 300 for priority-based call routing for next-generation 911 services, according to the present disclosure. In one example, the method 300 may be performed by a PSAP selecting function, such as the PSF 104 illustrated in FIG. 1 or one or more components thereof (e.g., a processor or controller of the base station). However, in other examples, the method 300 may be performed by another device, such as the computing system 400 of FIG. 4, discussed in further detail below. For the sake of discussion, the method 300 is described below as being performed by a processing system (where the processing system may comprise a component of a PSF 104, the computing system 400, or another device).

The method 300 begins in step 302. In step 304, the processing system may assign each user endpoint device of a plurality of user endpoint devices in an emergency telecommunications services network to one emergency priority class of a plurality of emergency priority classes.

In one example, the emergency telecommunications services network may be ESInet or a larger network within which ESInet may operate. Each PSAP in the emergency telecommunications services network may comprise a call center that receives incoming calls from users requesting emergency services (e.g., police, fire, ambulance, etc.). Moreover, each PSAP may be associated with a respective plurality of response teams, where each response team may comprise a team of one or more first response personnel and resources that can be dispatched to respond to an emergency. For instance, in one example, a response team might comprise a police vehicle and one or more police officers travelling in the police vehicle, or an ambulance vehicle and one or more emergency medical technicians travelling in the ambulance vehicle. The number of response teams associated with each PSAP may vary from PSAP to PSAP.

In one example, each user endpoint device of the plurality of user endpoint devices may be associated with one or more human users of the emergency telecommunications services network. These human users may include first responders (e.g., providers of emergency services) as well as civilian users (e.g., users of emergency services).

In one example, the plurality of emergency priority classes may be predefined, and each emergency priority class may be associated with a different relative priority level. For instance, the plurality of emergency priority classes may include Priority 1, Priority 2, and Priority 3, where the relative priority associated with Priority 1 is the highest, the relative priority associated with Priority 3 is the lowest, and the relative priority associated with Priority 2 is somewhere between the relative priority of Priority 1 and the relative priority of Priority 3. Although this example utilizes three emergency priority classes, it will be appreciated that any number of emergency priority classes may be defined.

The plurality of user endpoint devices may be assigned among the plurality of emergency priority classes in any number of ways. For instance, in one example, user endpoint devices associated with first responders may be assigned to the highest emergency priority class of the plurality of emergency priority classes.

In step 306, the processing system may detect that resource usage within the emergency telecommunications services network has exceeded a threshold usage. Broadly, resource usage that exceeds the threshold usage may indicate congestion within the emergency telecommunications services network (e.g., a high number of calls for emergency services being placed at the same time). For instance, the threshold usage may be based on threshold values for one or more network performance metrics (e.g., throughput, delay, number of dropped calls, etc.). In another example, the threshold usage may be based on a total number of calls being handled by the PSAPs of the emergency telecommunications services network or an average call waiting time across all of the PSAPs of the emergency telecommunications services network.

In step 308, the processing system may determine, based on the assigning, an order of priority for a subset of the plurality of user endpoint devices that is currently placing calls to emergency services.

In one example, the order of priority may be determined using a proportional-fairness utility function g(k), e.g.:

$$g ( k ) = {P}_{k} * {Q}_{k} \qquad ( EQN . 2 )$$

where k represents one user endpoint device of the plurality of user endpoint devices, Pₖ represents the emergency priority class assigned to the user endpoint device k, and Qₖ represents the current call waiting time associated with a call to emergency services that was placed by the user endpoint device k. It should be noted, however, that EQN. 2 represents just one way in which a proportional-fairness utility function may be calculated. In other examples, a different monotonically increasing function on the parameters Pₖ and Qₖ could be used to determine the order of priority.

In one example, once the proportional-fairness utility function g(k) has been calculated for each user endpoint device in the subset, the user endpoint devices in the subset may be ranked in order of descending value of g(k).

In step 310, the processing system may schedule the calls according to the order of priority. In one example, the calls are scheduled according to the ranking of the subset. For instance, the call associated with the user endpoint device having the highest g(k) value is scheduled first, then the call associated with the user endpoint device having the next highest g(k) value is scheduled next, and so on. The method 300 may end in step 312.

In one example, the method 200 and method 300 may be used in combination to route high priority calls for emergency services to the first responders who are best equipped to respond when the network is congested.

Although not expressly specified above, one or more steps of the method 200 or the method 300 may include a storing, displaying, and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 or FIG. 3 that recite a determining operation or involve a decision do not necessarily require that both branches of the determining operation be practiced. In other words, one of the branches of the determining operation can be deemed as an optional step. Furthermore, operations, steps or blocks of the above described method(s) can be combined, separated, and/or performed in a different order from that described above, without departing from the examples of the present disclosure.

FIG. 4 depicts a high-level block diagram of a computing device specifically programmed to perform the functions described herein. For example, any one or more components or devices illustrated in FIG. 1 or described in connection with the method 200 or method 300 may be implemented as the system 400. For instance, the PSF 104 of FIG. 1 (such as might be used to perform the method 200 or the method 300) could be implemented as illustrated in FIG. 4. As depicted in FIG. 4, the system 400 comprises a hardware processor element 402, a memory 404, a module 405 for location- and workload-based call routing for next-generation 911 services, and various input/output (I/O) devices 406.

The hardware processor 402 may comprise, for example, a microprocessor, a central processing unit (CPU), or the like. The memory 404 may comprise, for example, random access memory (RAM), read only memory (ROM), a disk drive, an optical drive, a magnetic drive, and/or a Universal Serial Bus (USB) drive. The module 405 for location- and workload-based call routing for next-generation 911 services may include circuitry and/or logic for routing calls in an emergency telecommunications services network. The input/output devices 406 may include, for example, storage devices (including but not limited to, a tape drive, a floppy drive, a hard disk drive or a compact disk drive), a receiver, a transmitter, a fiber optic communications line, an output port, or a user input device (such as a keyboard, a keypad, a mouse, and the like).

Although only one processor element is shown, it should be noted that the computer may employ a plurality of processor elements. Furthermore, although only one specific-purpose computer is shown in the Figure, if the method(s) as discussed above is implemented in a distributed or parallel manner for a particular illustrative example, i.e., the steps of the above method(s) or the entire method(s) are implemented across multiple or parallel specific-purpose computers, then the specific-purpose computer of this Figure is intended to represent each of those multiple specific-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for location- and workload-based call routing for next-generation 911 services can be loaded into memory 404 and executed by hardware processor element 402 to implement the steps, functions or operations as discussed above in connection with the example method 200 or example method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for location- and workload-based call routing for next-generation 911 services (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
receiving, by a processing system including at least one processor from each public safety answering point of a plurality of public safety answering points in an emergency telecommunications services network, a respective set of data, where the respective set of data comprises real-time workload data for the each public safety answering point and real-time workload data for each response team of a plurality of response teams associated with the each public safety answering point;
receiving, by the processing system from a user endpoint device, a call requesting an emergency service;
determining, by the processing system, a physical location of the user endpoint device;
calculating, by the processing system based on the physical location, the real-time workload data for the each response team, and real-time road traffic data, a plurality of travel times, wherein each travel time of the plurality of travel times represents an estimated amount of time for one response team of the plurality of response teams associated with the each public safety answering point to reach the physical location;
estimating, by the processing system based on the plurality of travel times and on the real-time workload data for the each public safety answering point, a plurality of response times, wherein each response time of the plurality of response times represents a time to respond to the call;
selecting, by the processing system based on the plurality of response times, a first public safety answering point of the plurality of public safety answering points and a first response team of the plurality of response teams to assign to the call; and
routing, by the processing system, the call to at least one of: the first public safety answering point or the first response team.

2. The method of claim 1, wherein the emergency telecommunications services network is an emergency services internet protocol network.

3. The method of claim 1, wherein each response team of the plurality of response teams comprises at least one of: personnel and resources that are capable of being dispatched to respond to emergencies.

4. The method of claim 1, wherein the each public safety answering point reports the respective set of data to the processing system periodically.

5. The method of claim 4, wherein each respective response team of the plurality of response teams reports the respective workload data for each respective response team to a respective public safety answering point of the plurality of public safety answering points periodically.

6. The method of claim 1, wherein the real-time workload data for the each response team includes at least one of: a current physical location of the each response team, whether the each response team is currently idle or currently responding to an emergency, or an estimated time for the each response team to finish responding to an emergency the each response team is currently responding to.

7. The method of claim 1, wherein the real-time workload data for the each public safety answering point includes at least one of: a call volume currently being handled by the each public safety answering point or a current average call waiting time for incoming calls to the each public safety answering point.

8. The method of claim 1, wherein the physical location of the user endpoint device comprises global positioning system coordinates provided in the call.

9. The method of claim 1, wherein the physical location of the user endpoint device is estimated through a triangulation based on locations of base stations of a radio access network with which the user endpoint device is capable of communicating with.

10. The method of claim 1, wherein the estimating comprises calculating, based on the physical location of the user endpoint device and on physical locations of the plurality of response teams provided in the real-time workload data for the each response team, a plurality of distances, wherein each distance of the plurality of distances represents a distance between the user endpoint device and one response team of the plurality of response teams.

11. The method of claim 10, wherein the real-time road traffic data comprises real-time road traffic data for roads making up a plurality of routes corresponding to the plurality of distances.

12. The method of claim 1, wherein the plurality of response teams is ranked in ascending order according to the plurality of travel times.

13. The method of claim 1, wherein the each response time is calculated as a current average call waiting time for one public service answering point of the plurality of public service answering point plus a travel time of the plurality of travel times for one response team of the plurality of response teams.

14. The method of claim 1, wherein the first public service answering point and the first response team comprise a combination of public service answering point and response team for which the response time is shortest among all combinations of the plurality of public service answering points and plurality of response teams.

15. The method of claim 1, wherein the routing comprises connecting the call to the first public service answering point and the first response team.

16. The method of claim 1, further comprising:
assigning, by the processing system, each user endpoint device of a plurality of user endpoint devices in the emergency telecommunications services network to one emergency priority class of a plurality of emergency priority classes.

17. The method of claim 16, further comprising:
detecting, by the processing system that a resource usage within the emergency telecommunications services network has exceeded a threshold usage;
determining, by the processing system based on the assigning, an order of priority for a subset of the plurality of user endpoint devices including the user endpoint device that is currently placing the call; and
scheduling, by the processing system, calls including the call according to the order of priority.

18. The method of claim 1, wherein the method is performed by a public service answering point selecting function of the emergency telecommunications services network.

19. A non-transitory computer-readable medium storing instructions which, when executed by a processing system including at least one processor, cause the processing system to perform operations, the operations comprising:
receiving, from each public safety answering point of a plurality of public safety answering points in an emergency telecommunications services network, a respective set of data, where the respective set of data comprises real-time workload data for the each public safety answering point and real-time workload data for each response team of a plurality of response teams associated with the each public safety answering point;
receiving from a user endpoint device, a call requesting an emergency service;
determining a physical location of the user endpoint device;
calculating, based on the physical location, the real-time workload data for the each response team, and real-time road traffic data, a plurality of travel times, wherein each travel time of the plurality of travel times represents an estimated amount of time for one response team of the plurality of response teams associated with the each public safety answering point to reach the physical location;
estimating, based on the plurality of travel times and on the real-time workload data for the each public safety answering point, a plurality of response times, wherein each response time of the plurality of response times represents a time to respond to the call;
selecting, based on the plurality of response times, a first public safety answering point of the plurality of public safety answering points and a first response team of the plurality of response teams to assign to the call; and
routing the call to at least one of: the first public safety answering point or the first response team.

20. A system comprising:
a processing system including at least one processor; and
a non-transitory computer-readable medium storing instructions which, when executed by the processing system, cause the processing system to perform operations, the operations comprising:
receiving, from each public safety answering point of a plurality of public safety answering points in an emergency telecommunications services network, a respective set of data, where the respective set of data comprises real-time workload data for the each public safety answering point and real-time workload data for each response team of a plurality of response teams associated with the each public safety answering point;
receiving from a user endpoint device, a call requesting an emergency service;
determining a physical location of the user endpoint device;
calculating, based on the physical location, the real-time workload data for the each response team, and real-time road traffic data, a plurality of travel times, wherein each travel time of the plurality of travel times represents an estimated amount of time for one response team of the plurality of response teams associated with the each public safety answering point to reach the physical location;
estimating, based on the plurality of travel times and on the real-time workload data for the each public safety answering point, a plurality of response times, wherein each response time of the plurality of response times represents a time to respond to the call;
selecting, based on the plurality of response times, a first public safety answering point of the plurality of public safety answering points and a first response team of the plurality of response teams to assign to the call; and
routing the call to at least one of: the first public safety answering point or the first response team.
